(19) United States
(12) Patent Application Publication
(10) Pub. No.: US 2008/0306686 A1
(43) Pub. Date: Dec. 11, 2008

(54) Navigation apparatuses, methods, and programs

(75) Inventor: Takaaki Nakayama, Okazaki (JP)

Correspondence Address: OLIFF & BERRIDGE, PLC, P.O. BOX 320850, ALEXANDRIA, VA, 22320-4850, US

(73) Assignee: AISIN AW CO., LTD., Anjo-Shi (JP)

(21) Appl. No.: 12/153,572

(22) Filed: May 21, 2008

(30) Foreign Application Priority Data
Jun. 6, 2007 (JP) 2007-150235

(51) Int. Cl. G01C 21/30

(52) U.S. Cl. 701/211

(57) ABSTRACT

Navigation apparatuses, methods, and programs store plural types of speech guidance information, each of the plural types of speech guidance having an indication of success and an assigned priority level. The apparatuses, methods, and programs identify a guidance branch point along the route and provide speech guidance for the guidance branch point according to one of the plural types of speech guidance. The apparatuses, methods, and programs determine whether the vehicle traveled through the guidance branch point. If the vehicle traveled through the guidance branch point, the apparatuses, methods, and programs increase the indication of success for the provided type of speech guidance information. However, if the vehicle did not travel through the guidance branch point, the apparatuses, methods, and programs decrease the indication of success for the provided type of speech guidance information. The apparatuses, methods, and programs change the assigned priority levels of the stored types of speech guidance information based on the indication of success for each of the stored types of speech guidance information.

### INCORPORATION BY REFERENCE

The disclosure of Japanese Patent Application No. 2007-150235, filed on Jun. 6, 2007, including the specification, drawings and abstract, is incorporated herein by reference in its entirety.

### BACKGROUND

1. Related Technical Fields

Related technical fields include navigation apparatuses capable of changing priority levels of speech guidance information.

2. Related Art

Known navigation apparatuses provide speech branch-point guidance. In speech branch-point guidance, an additional phrase such as a landmark institution name, an intersection name, or a feature may be provided. That is, when there is an obstacle between a landmark institution and the position of a vehicle, by changing landmark information, a driver of the vehicle can easily travel appropriately through a guidance branch point (see, e.g., Japanese Unexamined Patent Application Publication No. 2003-57048).

### SUMMARY

In the above known apparatuses, additional phrases for speech branch-point guidance are determined on the basis of predetermined priority levels. However, easy-to-understand additional phrases for speech guidance are not always identical for all drivers. Even if there is an easy-to-understand additional phrase for a driver, another additional phrase having a higher priority level may be used for speech guidance.

Exemplary implementations of the broad principles described herein enable speech guidance to be given that is tailored to each driver.

Exemplary implementations provide apparatuses, methods, and programs that store plural types of speech guidance information, each of the plural types of speech guidance having an indication of success and an assigned priority level. The apparatuses, methods, and programs identify a guidance branch point along the route and provide speech guidance for the guidance branch point according to one of the plural types of speech guidance. The apparatuses, methods, and programs determine whether the vehicle traveled through the guidance branch point. If the vehicle traveled through the guidance branch point, the apparatuses, methods, and programs increase the indication of success for the provided type of speech guidance information. However, if the vehicle did not travel through the guidance branch point, the apparatuses, methods, and programs decrease the indication of success for the provided type of speech guidance information. The apparatuses, methods, and programs change the assigned priority levels of the stored types of speech guidance information based on the indication of success for each of the stored types of speech guidance information.

### BRIEF DESCRIPTION OF THE DRAWINGS

Exemplary implementations will now be described with reference to the accompanying drawings, wherein:

FIG. 1 is a block diagram showing an exemplary configuration of a navigation apparatus;

FIG. 2 is an illustration showing learning of details of speech guidance;

FIGS. 3A and 3B are illustrations showing exemplary types of speech guidance with learning results; and

FIG. 4 is a flowchart illustrating an exemplary speech guidance and priority level changing method.

### DETAILED DESCRIPTION OF EXEMPLARY IMPLEMENTATIONS

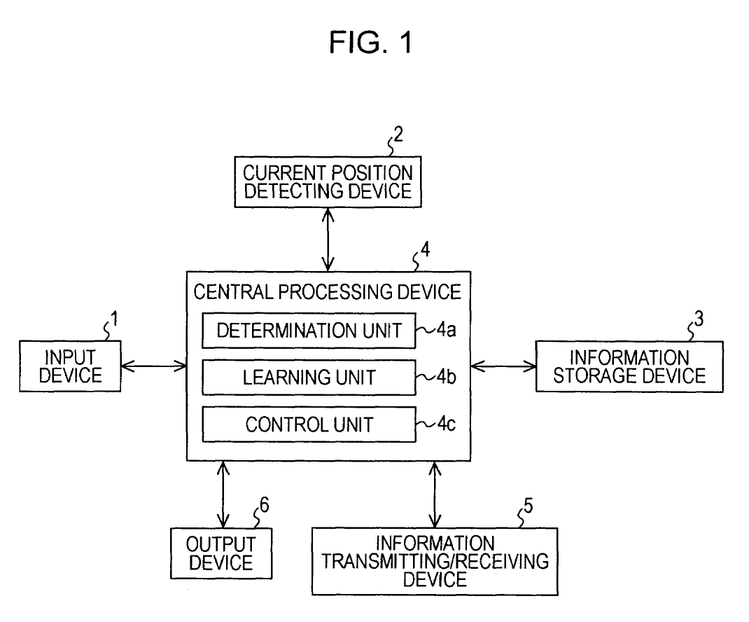

FIG. 1 shows an example of a navigation apparatus. The navigation apparatus includes an input device 1 for inputting route guidance information such as a departure place and a destination and a current position detecting device 2 for detecting information concerning a current position of the navigation apparatus. The navigation apparatus includes an information storage device 3 storing map data, navigation data necessary for route searching, display/speech-guidance data necessary for route searching, programs (applications and/or an operating system) for performing guidance such as display of maps, route searching, and speech guidance, etc. The navigation apparatus includes a determination unit 4a that determines whether the vehicle traveled through a guidance branch point in accordance with speech guidance.

The navigation apparatus includes a learning unit 4b that adds up, for each piece of speech guidance information, the number of times the vehicle has traveled through the guidance branch point in accordance with the speech guidance, and which learns a percentage of times that the vehicle has traveled in accordance with the speech guidance. The navigation apparatus includes and a control unit 4c for changing priority levels of pieces of the speech guidance information on the basis of a result of the learning. The navigation apparatus also includes a controller (e.g., central processing device 4) for navigation processing, performing a map display process, a route search process, a display/speech guidance process necessary for route guidance, and overall control of the system. The navigation apparatus includes an information transmitting/receiving device 5 for transmitting and receiving vehicle traveling information such as road information or traffic information, detecting information concerning the current position of the vehicle, and transmitting and receiving current position information. The navigation apparatus includes an output device 6, including a display and a speaker, for outputting route guidance information.

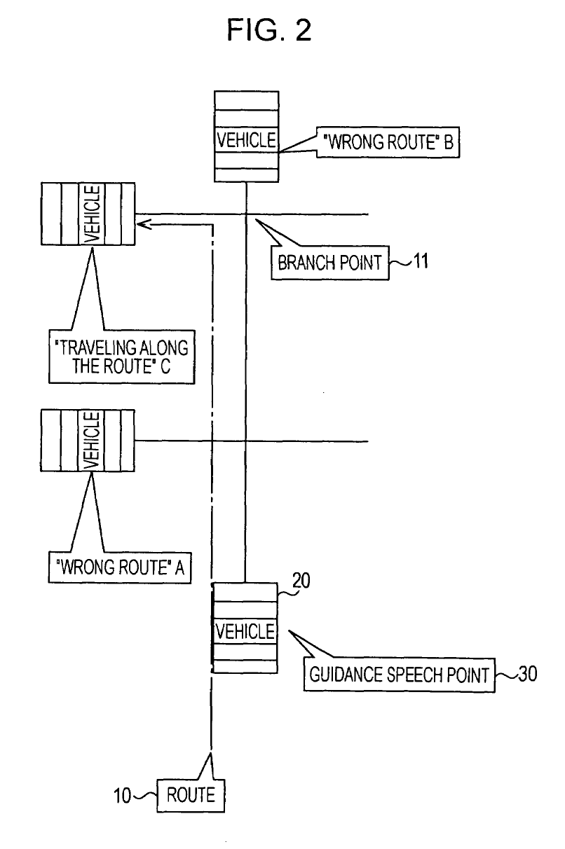

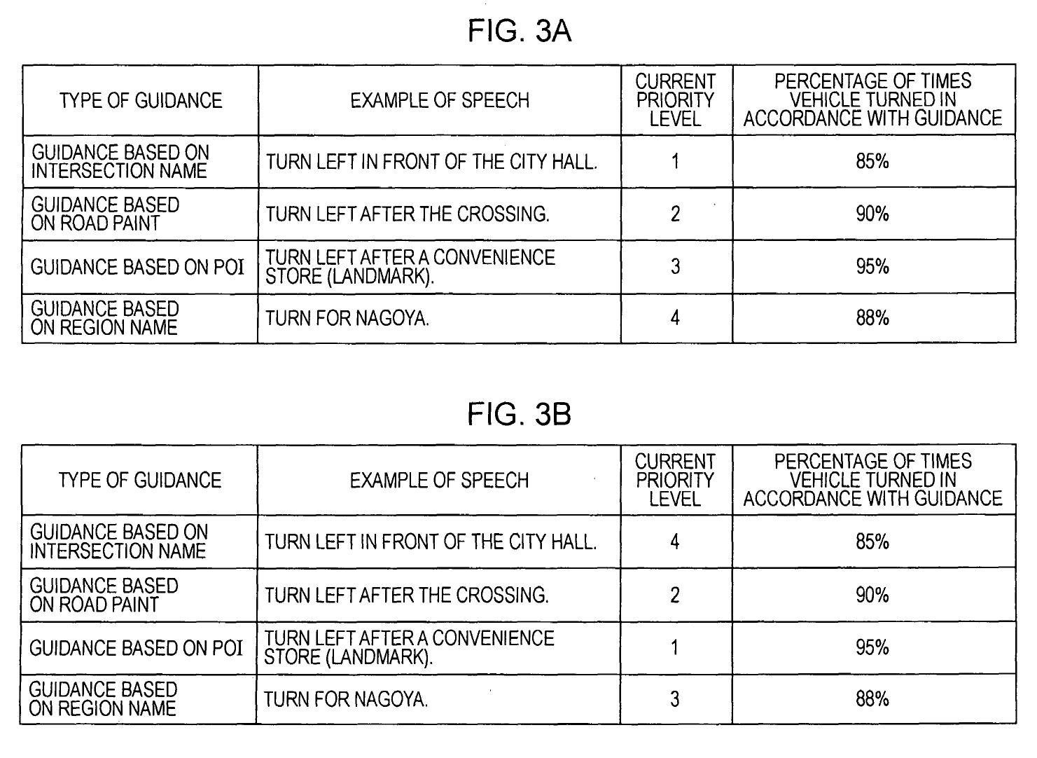

Next, an example of a process for changing priority levels of pieces of speech guidance information will be described below with reference to FIG. 2 that illustrates learning of details of speech guidance, and FIGS. 3A and 3B that show types of speech guidance and a learning result.

Referring to FIG. 2, a route 10, indicated by a dotted-chain line, denotes a guidance route to a destination searched for by the central processing device 4. The route 10 turns left at a guidance branch point 11. When a vehicle 20 reaches a guidance speech point 30 positioned a predetermined distance (e.g., 600 m or 300 m) before the guidance branch point 11, the navigation apparatus performs speech guidance including an additional phrase that recommends turning left at the guidance branch point 11. As shown in FIGS. 3A and 3B, the navigation apparatus performs speech guidance based on an intersection name, such as “TURN LEFT IN FRONT OF THE CITY HALL,” speech guidance based on road markings (feature), such as “TURN LEFT AFTER THE CROSSING,” speech guidance based on a point-of-interest (POI) landmark, such as “TURN LEFT AFTER A CONVENIENCE STORE,” or speech guidance based on a region name, such as “TURN LEFT FOR NAGOYA.”

When the navigation apparatus performs the speech guidance including one of the above examples of speech guidance, the determination unit 4a determines whether the status of the vehicle 20 was one of statuses: “WRONG ROUTE” A (the vehicle 20 incorrectly turned left before the guidance branch point 11); “WRONG ROUTE” B (the vehicle 20 incorrectly passed beyond the guidance branch point 11), and “TRAVELING ALONG THE ROUTE” C (the vehicle 20 correctly turned left at the guidance branch point 11).

Determination of whether the vehicle 20 traveled along the route 10 is performed, for example, on the basis of whether the central processing device 4 performed re-searching before and after the vehicle 20 passed beyond the guidance branch point 11, or on the basis of whether the current position detected by the current position detecting device 2, or the current position received by the information transmitting/receiving device 5 lies on the route 10. As described above, for various routes, various guidance branch points are set. For each type of speech guidance, the number of times the vehicle 20 has traveled in accordance with speech guidance, and the number of times the vehicle 20 has not traveled in accordance with speech guidance are collected and stored for learning, whereby a percentage of times that the vehicle 20 has traveled in accordance with speech guidance is determined.

In the example shown in FIGS. 3A and 3B, for each of the four types (speech guidance based on an intersection name, speech guidance based on road markings, speech guidance based on a POI landmark, and speech guidance based on a region name) of speech guidance including the additional phrases, at the time that learning data, for example, ten items of the learning data are stored, the learning data is regarded as valid, and a percentage of times that the vehicle 20 turned in accordance with speech guidance is determined. In this example, as shown in FIG. 3A, before learning, priority levels of types of speech guidance are arranged in the order of speech guidance based on an intersection name, speech guidance based on road markings, speech guidance based on a POI landmark, and speech guidance based on a region name. As a result of learning, a percentage of times that the vehicle 20 turned in accordance with speech guidance was 95% for the speech guidance based on a POI landmark, 90% for the speech guidance based on road markings, 88% for the speech guidance based on a region name, and 85% for the speech guidance based on an intersection name. Thus, as shown in FIG. 3B, the priority levels of types of speech guidance are changed in that order.

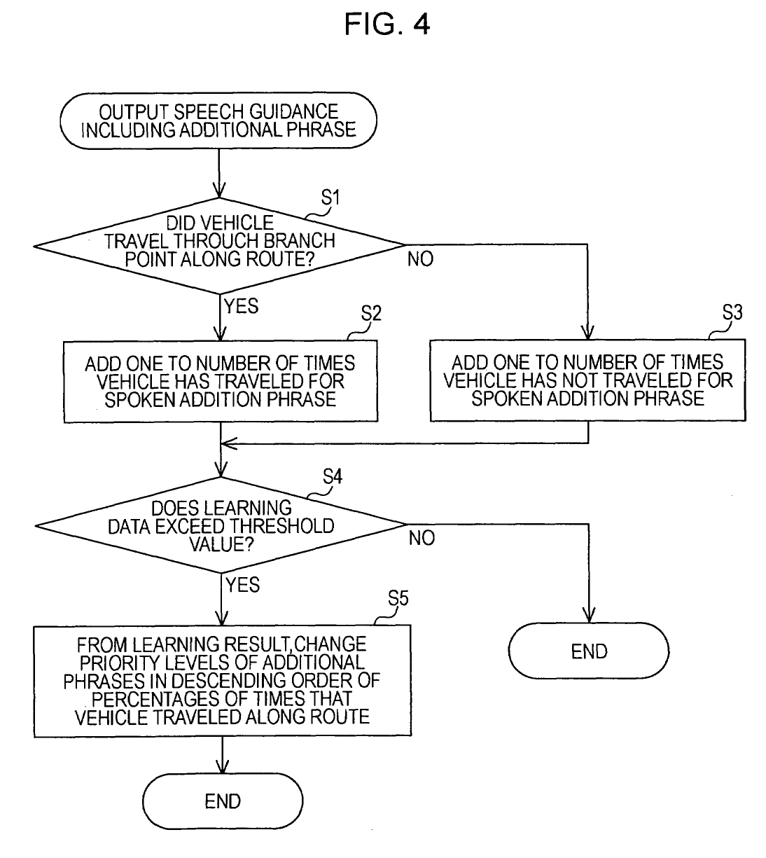

An exemplary method of learning and changing priority levels will be described with reference to FIG. 4. The exemplary method may be implemented, for example, by one or more components of the above-described navigation apparatus. For example, the method may be implemented in the form of a program 21 that is executed by the central processing device 4. However, even though the exemplary structure of the above-described navigation apparatus may be referenced in the description, it should be appreciated that the structure is exemplary and the exemplary method need not be limited by any of the above-described exemplary structure.

As shown in FIG. 4, in step S1, after a navigation apparatus outputs speech guidance for a guidance branch point including an additional phrase, it is determined whether a vehicle provided with the navigation apparatus traveled through the guidance branch point. If the vehicle has traveled along the route (S1=YES), in step S2, one is added to the number of times the vehicle has traveled along the route for the spoken additional phrase. If the vehicle did not travel along the route (S1=NO), in step S3, one is added to the number of times the vehicle has not traveled along the route.

In step S4, it is determined whether the number of learning data items exceeds a threshold value, for example, ten. If the number of learning data items exceeds the threshold value (S4=YES), in step S5, on the basis of a learning result, the priority levels of the additional phrases for speech guidance are changed in a descending order of percentages of times that the vehicle traveled along the route. In a case where the number of learning data items does not exceed the threshold value (S4=NO), the priority levels are not changed.

It is considered that, in the case of turning at a branch point, each driver has a different preference as to what is used as a main factor, such as a landmark or an intersection name. Therefore, by changing priority levels of additional phrases for speech guidance on the basis of the learning as described above, speech guidance which is not uniform and which meets a driver's preference can be performed. Thus, the driver can more accurately recognize guidance branch points because each guidance branch point will be identified by the type of speech guidance that is preferred by the driver.

While various features have been described in conjunction with the examples outlined above, various alternatives, modifications, variations, and/or improvements of those features and/or examples may be possible. Accordingly, the examples, as set forth above, are intended to be illustrative. Various changes may be made without departing from the broad spirit and scope of the underlying principles.

What is claimed is:

1. A navigation apparatus for a vehicle, the navigation apparatus capable of performing speech guidance along a route, the navigation apparatus comprising:
a memory that stores plural types of speech guidance information, each of the plural types of speech guidance having an indication of success and an assigned priority level; and
a controller that:
identifies a guidance branch point along the route;
provides speech guidance for the guidance branch point according to one of the plural types of speech guidance;
determines whether the vehicle traveled through the guidance branch point;
if the vehicle traveled through the guidance branch point, increases the indication of success for the provided type of speech guidance information;
if the vehicle did not travel through the guidance branch point, decreases the indication of success for the provided type of speech guidance information; and
changes the assigned priority levels of the stored types of speech guidance information based on the indication of success for each of the stored types of speech guidance information.

2. The navigation apparatus according to claim 1, wherein the indication of success for each of the plural types of speech guidance comprises a number of times that the vehicle traveled through a guidance branch point as a result of the type of speech guidance.

3. The navigation apparatus according to claim 1, wherein the indication of success for each of the plural types of speech guidance comprises a percentage of times that the vehicle traveled through a guidance branch point as a result of the type of speech guidance.

4. The navigation apparatus according to claim 1, wherein the controller determines whether the vehicle traveled through the guidance branch point based on whether re-searching of the route has been performed.

5. The navigation apparatus according to claim 1, wherein the controller determines whether the vehicle traveled through the guidance branch point based on whether a current position of the vehicle is on the route.

6. The navigation apparatus according to claim 1, wherein:
the controller changes the assigned priority levels of the stored types of speech guidance information when the stored indications of success for the stored types of speech guidance information have been increased or decreased more than a predetermined number of times.

7. A method for performing speech guidance along a route for a vehicle, the method comprising:
storing plural types of speech guidance information, each of the plural types of speech guidance having an indication of success and an assigned priority level;
identifying a guidance branch point along the route;
providing speech guidance for the guidance branch point according to one of the plural types of speech guidance;
determining whether the vehicle traveled through the guidance branch point;
if the vehicle traveled through the guidance branch point, increasing the indication of success for the provided type of speech guidance information;
if the vehicle did not travel through the guidance branch point, decreasing the indication of success for the provided type of speech guidance information; and
changing the assigned priority levels of the stored types of speech guidance information based on the indication of success for each of the stored types of speech guidance information.

8. The method according to claim 7, wherein the indication of success for each of the plural types of speech guidance comprises a number of times that the vehicle traveled through a guidance branch point as a result of the type of speech guidance.

9. The method according to claim 7, wherein the indication of success for each of the plural types of speech guidance comprises a percentage of times that the vehicle traveled through a guidance branch point as a result of the type of speech guidance.

10. The method according to claim 7, further comprising:
determining whether the vehicle traveled through the guidance branch point based on whether re-searching of the route has been performed.

11. The method according to claim 7, further comprising:
determining whether the vehicle traveled through the guidance branch point based on whether a current position of the vehicle is on the route.

12. The method according to claim 7, further comprising:
changing the assigned priority levels of the stored types of speech guidance information when the stored indications of success for the stored types of speech guidance information have been increased or decreased more than a predetermined number of times.

13. A computer-readable storage medium storing a computer-executable program usable to provide speech guidance, the program comprising:
instructions for storing plural types of speech guidance information, each of the plural types of speech guidance having an indication of success and an assigned priority level;
instructions for identifying a guidance branch point along the route;
instructions for providing speech guidance for the guidance branch point according to one of the plural types of speech guidance;
instructions for determining whether the vehicle traveled through the guidance branch point;
instructions for increasing, if the vehicle traveled through the guidance branch point, the indication of success for the provided type of speech guidance information;
instructions for decreasing, if the vehicle did not travel through the guidance branch point, the indication of success for the provided type of speech guidance information; and
instructions for changing the assigned priority levels of the stored types of speech guidance information based on the indication of success for each of the stored types of speech guidance information.

14. The computer-readable storage medium according to claim 13, wherein the indication of success for each of the plural types of speech guidance comprises a number of times that the vehicle traveled through a guidance branch point as a result of the type of speech guidance.

15. The computer-readable storage medium according to claim 13, wherein the indication of success for each of the plural types of speech guidance comprises a percentage of times that the vehicle traveled through a guidance branch point as a result of the type of speech guidance.

16. The computer-readable storage medium according to claim 13, the computer-executable program further comprising:
instructions for determining whether the vehicle traveled through the guidance branch point based on whether re-searching of the route has been performed.

17. The computer-readable storage medium according to claim 13, the computer-executable program further comprising:
instructions for determining whether the vehicle traveled through the guidance branch point based on whether a current position of the vehicle is on the route.

18. The computer-readable storage medium according to claim 13, the computer-executable program further comprising:
instructions for changing the assigned priority levels of the stored types of speech guidance information when the stored indications of success for the stored types of speech guidance information have been increased or decreased more than a predetermined number of times.
